(19) United States
(12) Patent Application Publication
(10) Pub. No.: US 2026/0273486 A1
(43) Pub. Date: Sep. 17, 2026

(54) PREMIXING APPARATUS

(71) Applicant: RINNAI CORPORATION, Aichi (JP)

(72) Inventor: Keigo ITAKURA, Aichi (JP)

(73) Assignee: RINNAI CORPORATION, Aichi (JP)

(21) Appl. No.: 19/163,215

(22) PCT Filed: Jan. 15, 2024
(86) PCT No.: PCT/JP2024/000824

§ 371 Date: Sep. 8, 2025

(30) Foreign Application Priority Data
May 15, 2023 (JP) 2023-079836

(51) Int. Cl. B01F 35/71; B01F 23/10; B01F 35/83; B01F 101/00; F16K 1/22

(52) U.S. Cl. CPC B01F 35/718051; B01F 23/10; B01F 35/833; B01F 2101/501; F16K 1/22

(57) ABSTRACT

In a premixing apparatus in which a butterfly valve for switching an air-resistance, a switching valve for a gas-resistance, and an interlocking mechanism for opening and closing the switching valve-in association with the opening or closing of the butterfly valve, which is connected to the rotational shaft of the butterfly valve-are provided, the interlocking mechanism being disposed in a mechanism chamber partitioned by a partitioning part relative to the air supply passage, and communicating with a downstream end part of the gas supply passage, and in which a pivotally supporting hole, through which the rotational shaft passes, is formed, fixation of the rotational shaft in the pivotally supporting hole due to corrosion, caused by intrusion of outer air containing a salt component into the pivotally supporting hole due to a difference between internal pressures of the air supply passage and the mechanism chamber, is prevented.

### TECHNICAL FIELD

The invention relates to a premixing apparatus that mixes a fuel gas with air and supplies an air-fuel mixture to a burner through a fan.

### BACKGROUND ART

Conventionally, as a premixing apparatus of this kind, there has been known the premixing apparatus as disclosed in Patent Document 1, in which a gas supply passage for supplying a fuel gas, with a gas-flow regulating valve interposed therein, has a downstream end thereof connected to a gas suction part provided with an air supply passage on an upstream side of the fan. The premixing apparatus includes an air-resistance switching device for switching, between large and small, a ventilation resistance at a portion of the air supply passage, which is located on an upstream side of the gas suction part, and a gas-resistance switching device for switching, between large and small, a ventilation resistance at a portion of the gas supply passage, which is located on a downstream side of a flow-amount regulating valve. Here, in a case where a proportional valve is used for the flow-amount regulating device, the proportional valve is controlled so that the fuel gas in an amount corresponding to a required combustion amount is supplied. Further, a fan rotational speed corresponding to the required combustion amount is controlled so that an excess air ratio of the air-fuel mixture supplied to the burner is kept constant. In addition, the flow-amount regulating valve may also be formed of a zero governor for maintaining a secondary gas pressure at atmospheric pressure. In this case, a supply amount of the fuel gas varies in proportion to a differential pressure between atmospheric pressure, i.e., the secondary gas pressure, and a negative pressure acting at the gas suction part. Since the negative pressure acting at the gas suction part varies corresponding to the fan rotational speed, the supply amount of the fuel gas varies in proportion to the fan rotational speed, that is, to a supply amount of air. Accordingly, the air-fuel mixture with a constant excess air ratio and corresponding to the required combustion amount is supplied to the burner by controlling the fan rotational speed corresponding to the requires combustion amount.

Meanwhile, in order to prevent occur poor exhaustion due to intrusion of wind into an exhaust tube for discharging a combustion gas from the burner, that is, in order to ensure wind-resistant performance, a lower limit of the fan rotational speed cannot be set too low. Thus, in a case where the required combustion amount is equal to or less than a predetermined value corresponding to the lower limit of the fan rotational speed, air in an amount corresponding to the required combustion amount cannot be supplied. Therefore, in the apparatus disclosed in Patent Document 1, in a case where the required combustion amount is less than or equal to the predetermined value mentioned above, a ventilation resistance of the air supply passage is increased by the air-resistance switching device, and the fan rotational speed is not reduced to the lower limit of the rotational speed or less, so that the air-fuel mixture in an amount corresponding to the required combustion amount less than or equal to the predetermined value, with the excess air ratio at the appropriate value, can be supplied. However, if only the ventilation resistance of the air supply passage, is increased, the negative pressure acting at the gas suction part increases, and the supply amount of the fuel gas becomes excessive, thereby lowering the air excess ratio of the air-fuel mixture supplied to the burner below the appropriate value. Therefore, in a case where the required combustion amount is relatively small, switching to a small-capacity state is performed so that the air-fuel mixture, in an amount corresponding to a relatively small required combustion amount and with the excess air ratio at the appropriate value, can be supplied. The small-capacity state is defined as a state in which the ventilation resistance of the air supply passage is made large by the air-resistance switching device, and a ventilation resistance of the gas supply passage is made large by the gas-resistance switching device. On the other hand, in a case where the required combustion amount is relatively large, switching to a large-capacity state is performed so that the air-fuel mixture in an amount corresponding to a relatively large required combustion amount, with the excess air ratio at the appropriate value, is supplied to the burner. The large-capacity state is defined as a state in which the ventilation resistance of the air supply passage and the ventilation resistance of the gas supply passage are made small.

In addition, in the apparatus disclosed in Patent Document 1, the air-resistance switching device is provided at a portion of the air supply passage located on the upstream side of the gas suction part, and is formed of a butterfly valve that is pivoted about a rotational shaft as a center to an opened posture parallel to a longitudinal direction of the air supply passage, and to a closed posture orthogonal to the longitudinal direction of the air supply passage. The gas-resistance switching device is formed of a switching valve that is provided in the gas supply passage and is capable of freely opening and closing. Thus, an interlocking mechanism is provided, which is connected to the rotational shaft of the butterfly valve so as to perform opening operation or closing operation of the switching valve in association with a pivotal movement of the butterfly valve to the opened posture or the closed posture of the butterfly valve. The interlocking mechanism is disposed in a mechanism chamber, which is partitioned by a partitioning part relative to a portion of the air supply passage where the butterfly valve is provided, and communicates with the downstream end of the gas supply passage. In the partitioning part, a pivotally supporting hole, through which the rotational shaft passes, is formed.

Meanwhile, an internal pressure of the mechanism chamber, which communicates with the downstream end of the gas supply passage, is lower than an internal pressure of the portion of the air supply passage that is partitioned from the mechanism chamber by the partitioning part due to the negative pressure acting at the gas suction part. Therefore, there are some cases in which outer air containing a salt component may intrude the mechanism chamber from the air supply passage through the pivotally supporting hole. As a result, the rotational shaft may corrode and eventually become fixed in the pivotally supporting hole, possibly leading to the occurrence of poor operation.

### PRIOR ART

### Patent Document

Patent Document 1: JP2020-46096A

### SUMMARY OF INVENTION

### Problem That the Invention is to be Solved

The invention has been made in view of the point mentioned above, and addresses a problem of providing a premixing apparatus that can suppress corrosion of the rotational shaft, thus preventing poor operation from occurring over a long period.

### Means for Solving the Problem

In order to solve the problem mentioned above, the invention provides a premixing apparatus, in which a fuel gas is mixed with air and an air-fuel mixture is supplied to a burner through a fan, and a gas supply passage for supplying a fuel gas, with a flow-amount regulating valve interposed therein, has a downstream end thereof connected to a gas suction part provided with an air supply passage on an upstream side of the fan, comprising: an air-resistance switching device for switching, between large and small, a ventilation resistance at a portion of the air supply passage, which is located on an upstream side of the gas suction part; and a gas-resistance switching device for switching, between large and small, a ventilation resistance at a portion of the gas supply passage, which is located on a downstream side of the flow-amount regulating valve, wherein the air-resistance switching device is provided at a portion of the air supply passage located on the upstream side of the gas suction part, and is formed of a butterfly valve that is pivoted about a rotational shaft as a center to an opened posture parallel to a longitudinal direction of the air supply passage, and to a closed posture orthogonal to the longitudinal direction of the air supply passage, wherein the gas-resistance switching device is formed of a switching valve that is provided in the gas supply passage and is capable of opening and closing, wherein an interlocking mechanism, which is connected to the rotational shaft of the butterfly valve so as to perform an opening operation or a closing operation of the switching valve in association with a pivotal movement of the butterfly valve to the opened posture or the closed posture, is disposed in a mechanism chamber, which is partitioned by a partitioning part relative to a portion of the air supply passage where the butterfly valve is provided, and which communicates with the downstream end of the gas supply passage, and wherein, in the partitioning part, a pivotally supporting hole, through which the rotational shaft passes, is formed, wherein: a seal member is provided at a portion of the pivotally supporting hole near the air supply passage, which seals a clearance between that portion and the rotational shaft.

According to the invention, intrusion of outer air into the pivotally supporting hole can be prevented by the seal member. Therefore, corrosion of the rotational shaft, caused by a salt component contained in the outer air, is suppressed, thereby preventing the occurrence of poor operation due to fixation of the rotational shaft in the pivotally supporting hole over a long period.

It should be noted that, in a case where the premixing apparatus is provided with a casing having, inside thereof, the mechanism chamber and a cavity part in which a portion of the air supply passage, at which the butterfly valve is disposed, are housed, and a cylindrical body surrounding a portion of the air supply passage at which the butterfly valve is disposed is mounted in the cavity part, it is desirable that the partitioning part is integrally provided at the cylindrical body. Here, in a case where the partitioning part is provided with the casing, attachment operation of the seal member in the pivotally supporting hole formed in the partitioning part becomes troublesome. On the contrary, in a case where the partitioning part is integrally provided with the cylindrical part, the seal member can be attached in the pivotally supporting hole before mounting the cylindrical part in the cavity part of the casing, thereby facilitating the attachment operation of the seal member.

In addition, in this case, it is desirable that a second seal member for sealing a clearance between the cylindrical body and an inner-wall surface of the cavity part, which is to be positioned on an upstream side from a formed position of the pivotally supporting hole, be provided. According to this, intrusion of the outer air into the clearance between the cylindrical body and the inner-wall surface of the cavity part can be prevented by the second seal member. As a result, corrosion of the rotational shaft due to intrusion of the outer air containing the salt component from the clearance between the cylindrical body and the inner-wall surface of the cavity part can also be suppressed.

### BRIEF DESCRIPTION OF THE DRAWINGS

FIG. 1 is a side sectional view showing a premixing apparatus according to an embodiment of the invention.

FIG. 2 is a cross-sectional view taken along a II-II line of FIG. 1.

FIG. 3 is a cross-sectional view taken along a III-III line of FIG. 1.

### MODES FOR CARRYING OUT THE INVENTION

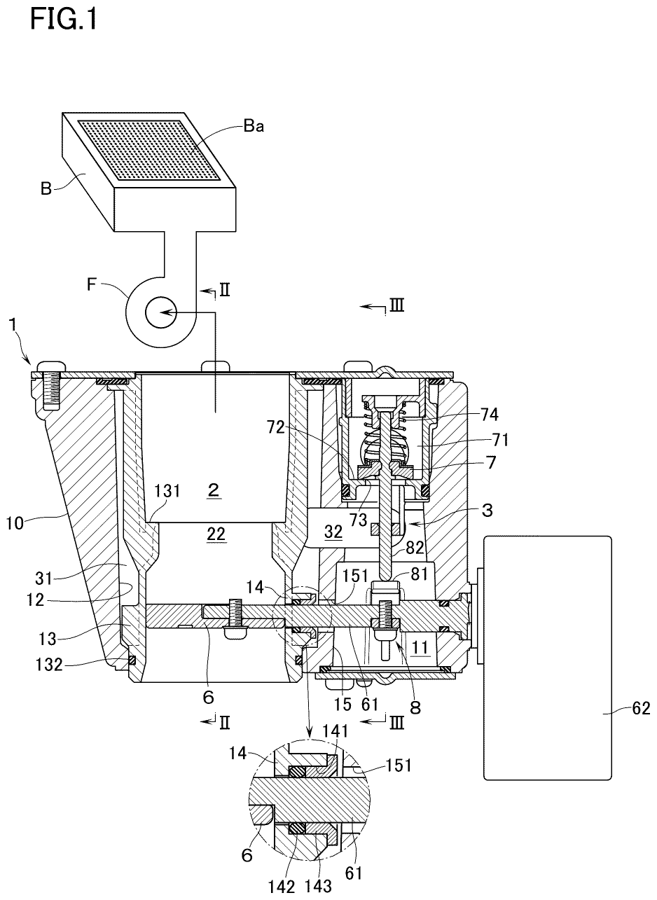

With reference to FIG. 1, mark “B” denotes a burner, such as a totally primary-aerated burner, having a combustion surface Ba on which an air-fuel mixture ejected therefrom is combusted. A fan F is connected to the burner B. A fuel gas is mixed with air, and the air-fuel mixture is supplied to the burner B through the fan F by a premixing apparatus 1 according to an embodiment of the invention.

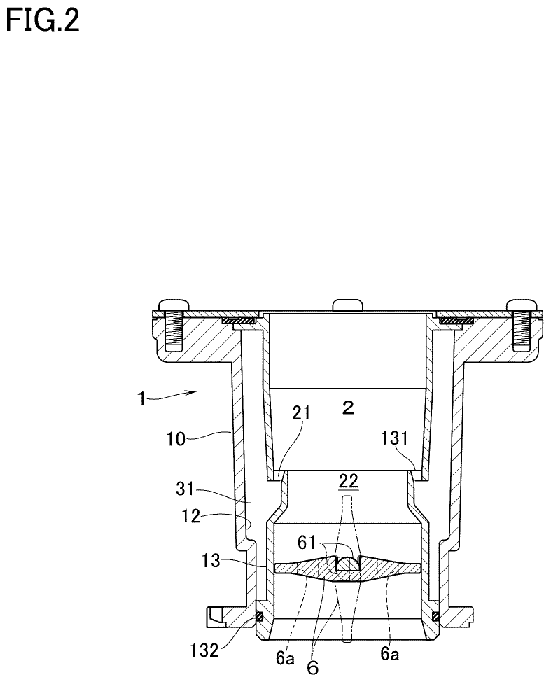

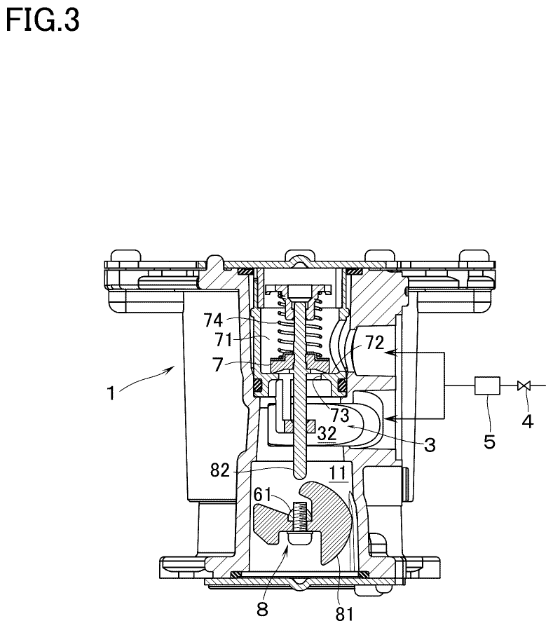

The premixing apparatus 1 is provided with an air supply passage 2 on an upstream side of the fan F, and a gas supply passage 3 for supplying a fuel gas. As shown in FIG. 3, a master valve 4 and a zero governor 5, serving as the flow-amount regulating valve, are interposed at an upstream part of the gas supply passage 3. Further, a downstream end of the gas supply passage 3 is connected to a gas suction part 21 provided at the air supply passage 2 (see FIG. 2).

It should be noted that, in the embodiment, the premixing apparatus 1 is provided with a casing 10 having, inside thereof, a mechanism chamber 11 mentioned below, and a cavity part 12 in which a portion of the air supply passage 2, at which a butterfly valve 6 mentioned below is disposed, is housed. In the cavity part 12, a cylindrical body 13 surrounding a portion of the air supply passage 2, at which the butterfly valve 6 is disposed, is mounted. The cavity part 12 extends upward from a lower part in which a portion of the air supply passage 2, at which the butterfly valve 6 is disposed, and the cylindrical body 13 also extends upward from a lower part surrounding a portion of the air supply passage 2, at which the butterfly valve 6 is disposed. A gas chamber 31 is formed of a space between an inner-wall surface of the cavity part 12 and the cylindrical body 13, and is provided at the downstream end of the gas supply passage 3. In addition, a venturi part 22, adjacent to a downstream side of a portion at which the butterfly valve 6 is disposed, is provided by reducing an inner diameter of an intermediate part of the cylindrical body 13 toward a downstream side, that is, upward. Further, the inner diameter of the cylindrical body 13 increases at a step 131 at an upper end of the venturi part 22. In this step 131, as shown in FIG. 2, a plurality of arcuate openings are formed in a circumferential direction, each opening communicating the gas chamber 31 with the air supply passage 2 in the cylindrical body 13 and forming the gas suction part 21.

The premixing apparatus 1 is provided with an air-resistance switching device for switching a ventilation resistance at a portion of the air supply passage 2 on the upstream side from the gas suction part 21 between large and small, and a gas-resistance switching device for switching a ventilation resistance at a portion of the gas supply passage 3 on a downstream side from the zero governor 5 between large and small. When a required combustion amount is less than or equal to a predetermined value, the ventilation resistance of the air supply passage 2 is made large by the air-resistance switching device, and the ventilation resistance of the gas supply passage 3 is made large by the gas-resistance switching device, thereby switching to a small-capacity state, and the air-fuel mixture in an amount corresponding to the required combustion amount, which is less than or equal to the predetermined value, can be supplied. On the other hand, when the required combustion amount exceeds the predetermined value, the ventilation resistance of the air supply passage 2 is made small by the air-resistance switching device, and the ventilation resistance of the gas supply passage 3 is made small by the gas-resistance switching device, thereby returning to a large-capacity state.

The air-resistance switching device is formed of a butterfly valve 6 that is pivoted around a rotational shaft 61 as a center to an opened posture parallel to a longitudinal direction of the air supply passage 2, shown by a dotted line in FIG. 2, and to a closed posture orthogonal to the longitudinal direction of air supply passage 2, shown by a rigid line in FIG. 2. An actuator 62, such as a stepping motor, is connected to the rotational shaft 61 of the butterfly valve 6. In addition, a plurality of air-flow-holes 6a, in which air flows at the closed posture, are formed in the butterfly valve 6. At the time of switching to the small-capacity state, the butterfly valve 6 is switched to the closed posture by actuation of the actuator 62. On the other hand, at the time of switching to the large-capacity state, the butterfly valve 6 is switched to the opened posture by actuation of the actuator 62. When the butterfly valve 6 is switched to the closed posture, an airflow is substantially limited, and the ventilation resistance becomes large.

In addition, inside the casing 2, a passage portion 32, which always communicates with the gas chamber 31, and a valve chamber 71, arranged in parallel to this passage portion 32, are provided as a portion of the gas supply passage 3 adjacent to an upstream side of the gas chamber 31. Further, in the valve chamber 71, a switching valve 7 is provided, which opens and closes a valve hole 73 formed in a valve seat 72 at a lower end of the valve chamber 71 and communicating with the passage portion 32. When the switching valve 7 is switched to a closed state, where the switching valve 7 is seated on the valve seat 72 to close the valve hole 73, the gas flow through the valve chamber 71 is blocked, and the ventilation resistance of the gas supply passage 3 becomes large.

The switching valve 7 is opened and closed through an interlocking mechanism 8, which is connected to the rotational shaft 61 of the butterfly valve 6, in association with a pivotal movement of the butterfly valve 6 to the opened posture or the closed posture. As shown in FIGS. 1, 3, the interlocking mechanism 8 is disposed in the mechanism chamber 11 inside the casing 10, the mechanism chamber 11 being partitioned by a partitioning part 14 relative to a portion of the air supply passage 2 in which the butterfly valve 6 is provided, and communicating, through the passage portion 32, with the gas chamber 31 serving as a downstream end part of the gas supply passage 3. The rotational shaft 61 of the butterfly valve 6 passes through a pivotally supporting hole 141 formed in the partitioning part 14 and protrudes into the mechanism chamber 11. Furthermore, a cam 81, which is one of the constituent elements of the interlocking mechanism 8, is fitted to a protruding portion of the rotational shaft 61 protruding inside the mechanism chamber 11. Moreover, the interlocking mechanism 8 is provided with a rod 82, a lower end of which contacts the cam 81, and which extends upward to be connected to the switching valve 7. When the butterfly valve 6 is pivoted to the opened posture, the rod 82 is pushed up by a pivotal movement of the cam 81 through the rotational shaft 61, and the switching valve 7 moves upward against an urging force of a valve spring 74, namely, the switching valve 7 is thereby operated to open. On the other hand, when the butterfly valve 6 is pivoted to the closed posture, the pushing-up of the rod 82 is released by the pivotal movement of the cam 81 through the rotational shaft 61, and the switching valve 7 moves downward by the urging force of the valve spring 74, namely, the switching valve 7 is thereby operated to close.

Meanwhile, an internal pressure of the mechanism chamber 11, which communicates with the downstream end part of the gas supply passage 3, becomes lower than an internal pressure of a portion of the air supply passage 2, which is partitioned from the mechanism chamber 11 by the partioning part 14, due to a negative pressure acting at the gas suction part 21. Therefore, there are some cases in which outer air containing a salt component may intrude the mechanism chamber 11 from the air supply passage 2 through the pivotally supporting hole 141 of the partitioning part 14. As a result, the rotational shaft 61 of the butterfly valve 6 may corrode and eventually become fixed in the pivotally supporting hole 141, possibly leading to the occurrence of poor operation.

Then, in the embodiment, a seal member 142, made of an O-ring, is provided at a portion of the pivotally supporting hole 141 near the air supply passage 2, which seals a clearance between that portion and the rotational shaft 141. Incidentally, the O-ring 142 is retained by a bush 143 to be attached to the pivotally supporting hole 141 from an opposite side of the air supply passage 2. Thus, the bush 143 is slidably in contact with a circumferential surface of the rotational shaft 61 so that the rotational shaft 61 is pivotally supported.

As mentioned above, in a case where the seal member 142 is provided, outer air can be prevented from intruding in the pivotally supporting hole 141 from the air supply passage 2 toward the mechanism chamber 11 by the seal member. Accordingly, corrosion of the rotational shaft 61, caused by a salt component contained in outer air, is suppressed, thereby preventing the occurrence of poor operation due to fixation of the rotational shaft 61 in the pivotally supporting hole 141 over a long period.

Here, a partition wall part 15, which is positioned between the mechanism chamber 11 and the cavity part 12, is provided in the casing 10. Therefore, the partitioning part 14 may be formed of this partition wall part 15. In this case, the pivotally supporting hole 141 is formed in the partition wall part 15. However, in accordance with this, it is necessary to attach the seal member 142 in the pivotally supporting hole 141 by inserting a human hand into the mechanism chamber 11 inside the casing, making an operation for attachment of the seal member 11 troublesome.

Then, in the embodiment, a large-diameter hole 151, in which the rotational shaft 61 is inserted with a clearance, is formed in the partitioning part 14. Furthermore, the partitioning part 14 is integrally provided with the cylindrical body 13. According to this, the seal member 142 can be attached in the pivotally supporting hole 141 formed in the partitioning part 14 before mounting the cylindrical body 13 in the cavity part 12 of the casing 10, thereby facilitating the attachment operation of the seal member 142.

In addition, in the embodiment, a second seal member 132 for sealing a clearance between the cylindrical body 13 and an inner-wall surface of the cavity part 12, which is to be positioned on an upstream side from a formed position of the pivotally supporting hole 141, is provided. According to this, intrusion of outer air into the clearance between the cylindrical body 13 and the inner-wall surface of the cavity part 12 can be prevented by the second seal member 132. As a result, corrosion of the rotational shaft 61 due to intrusion of outer air containing the salt component from the clearance between the cylindrical body 13 and the inner-wall surface of the cavity part 12 can also be suppressed.

In the above, the embodiment of the invention is explained referring to the figures, the invention is not limited to this embodiment. For example, in the embodiment mentioned above, although the flow-amount regulating valve interposed in the gas supply passage 3 is formed of the zero governor 5, the flow-amount regulating valve may be formed of a proportional valve. In addition, in the embodiment mentioned above, although the interlocking mechanism 8 is formed of the cam mechanism having the cam 31, the interlocking mechanism 8 may be formed of a mechanism other than the cam mechanism.

### EXPLANATION OF MARKS

B Burner
F Fan
1 Premixing apparatus
10 Casing
11 Mechanism chamber
12 Cavity part
13 Cylindrical body
132 Second seal member
14 Partitioning part
141 Pivotally supporting hole
142 Seal member
2 Air supply passage
21 Gas suction part
3 Gas supply passage
5 Zero governor (Flow-amount regulating valve)
6 Butterfly valve
61 Rotational shaft

What is claimed is:

1. A premixing apparatus, in which a fuel gas is mixed with air and an air-fuel mixture is supplied to a burner through a fan, and a gas supply passage for supplying the fuel gas, with a flow-amount regulating valve interposed therein, has a downstream end thereof connected to a gas suction part provided with an air supply passage on an upstream side of the fan, comprising:
an air-resistance switching device for switching, between large and small, a ventilation resistance at a portion of the air supply passage, which is located on an upstream side of the gas suction part; and
a gas-resistance switching device for switching, between large and small, a-ventilation resistance at a portion of the gas supply passage, which is located on a downstream side of the flow-amount regulating valve,
wherein the air-resistance switching device is provided at a portion of the air supply passage located on the upstream side of the gas suction part, and is formed of a butterfly valve that is pivoted about a rotational shaft as a center to an opened posture parallel to a longitudinal direction of the air supply passage, and to a closed posture orthogonal to the longitudinal direction of the air supply passage, wherein the gas-resistance switching device is formed of a switching valve that is provided in the gas supply passage and is capable of opening and closing, wherein an interlocking mechanism, which is connected to the rotational shaft of the butterfly valve so as to perform an opening operation or a closing operation of the switching valve in association with a pivotal movement of the butterfly valve to the opened posture or the closed posture, is disposed in a mechanism chamber, which is partitioned by a partitioning part relative to a portion of the air supply passage where the butterfly valve is provided, and which communicates with the downstream end of the gas supply passage, and wherein, in the partitioning part, a pivotally supporting hole, through which the rotational shaft passes, is formed,
wherein:
a seal member is provided at a portion of the pivotally supporting hole near the air supply passage, which seals a clearance between that portion and the rotational shaft.

2. The premixing apparatus according to claim 1, wherein the premixing apparatus is provided with a casing having, inside thereof, the mechanism chamber and a cavity part in which a portion of the air supply passage, at which the butterfly valve is disposed, are housed, and a cylindrical body surrounding a portion of the air supply passage at which the butterfly valve is disposed is mounted in the cavity part,
wherein:
the partitioning part is integrally provided at the cylindrical body.

3. The premixing apparatus according to claim 2, wherein a second seal member for sealing a clearance between the cylindrical body and an inner-wall surface of the cavity part, which is to be positioned on an upstream side from a formed position of the pivotally supporting hole, is provided.
